(19) United States
(12) Patent Application Publication
(10) Pub. No.: US 2023/0036686 A1
(43) Pub. Date: Feb. 2, 2023

(54) METHOD AND DEVICE FOR MONITORING ELECTRONIC DEVICES

(71) Applicant: Lenovo (Singapore) Pte. Ltd., New Tech Park (SG)

(72) Inventors: Matthew Fardig, Boonville, IN (US); Jordan Hansen, Boise, ID (US)

(21) Appl. No.: 17/387,494

(22) Filed: Jul. 28, 2021

(51) Int. Cl. G06F 11/30; G06F 11/34; G06N 20/00

(52) U.S. Cl. CPC G06F 11/3096; G06F 11/3438; G06F 11/3093; G06N 20/00

(57) ABSTRACT

A monitoring system for monitoring at least one secondary electronic device is provided that includes a monitoring electronic device configured to electronically communicate with the at least one secondary electronic device via a network. The monitoring electronic device has a memory storing program instructions and one or more processors that, when executing the program instructions, are configured to obtain context data related to the secondary electronic device at a first rate through the network, analyze the context data to determine content associated with a user of the secondary electronic device, and vary the first rate to a second rate based on the content determined.

### BACKGROUND

Embodiments herein generally relate to methods and devices for monitoring electronic devices.

There are a lot of different types of monitoring applications, including applications to monitor security, applications to monitor user safety (student safety, etc.) as well as applications to send metadata to allow a remote party to see what is being done at a particular electronic device. In order to do this, an application is installed and run on a secondary electronic device to do whatever sort of monitoring is required. As an example, to provide student safety, an application may be installed on the secondary electronic device of a student to obtain context data such as by monitoring keystrokes, periodically taking screen shots to send to a monitoring electronic device, and periodically performing optical character recognition (OCR) scans to send to monitoring electronic device for evaluation.

A big challenge with these applications is that sometimes they are quite memory intensive. This can lead to a negative experience on the secondary electronic devices as system resources are consumed by these processes. The negative experience can include slowing of processing, loading, uploading, etc. One method for addressing the memory load is by decreasing the frequency, or rate, at which the application obtains the context data. Problematically, by decreasing the rate at which context data is obtained, decreases the chance that context data that indicates a student safety issue is presented will be obtained in time to prevent or address the safety issues.

### SUMMARY

In accordance with embodiments herein, a monitoring system for monitoring at least one secondary electronic device is provided that includes a monitoring electronic device configured to electronically communicate with the at least one secondary electronic device via a network. The monitoring electronic device has a memory storing program instructions and one or more processors that, when executing the program instructions, are configured to obtain context data related to the secondary electronic device at a first rate through the network, analyze the context data to determine content associated with a user of the secondary electronic device, and vary the first rate to a second rate based on the content determined.

Optionally, the one or more processors are further configured to obtain auxiliary context data from a manual input by a user of the monitoring electronic device. In one aspect, the context data includes at least one of keystroke data, website data, or email data. In another aspect, the one or more processors are further configured to obtain a user profile of the user of the secondary electronic device. In yet another aspect, the user profile includes names of friends or associates. In one example, the one or more processors further configured to identify at least one other secondary electronic device that has communicated with the secondary electronic device. In another example, to analyze the context data, the one or more processors are further configured to read text on a display of the secondary electronic device with optical character recognition.

Optionally, to analyze the context data, the one or more processors are further configured to compare a screen shot with a stored screen shot. In one aspect, the one or more processors are further configured to determine the second rate based on the content. In another aspect, to determine the second rate based on the content includes analyzing the content with an artificial intelligence algorithm. In one example, the first rate is less than the second rate.

In accordance with embodiments herein a computer implemented method to monitor a secondary electronic device is provided. The method, includes to obtain context data related to the secondary electronic device at a first rate through a network, analyze the context data to determine content associated with a user of the secondary electronic device, and vary the first rate to a second rate based on the content determined.

Optionally, the method also includes to obtain auxiliary context data from a manual input by a user of a monitoring electronic device. In one aspect, the method includes to obtain a user profile of the user of the secondary electronic device. In one example, the method includes to identify at least one other secondary electronic device that has communicated with the secondary electronic device. In another example the method includes to analyze the context data, and to read text on a display of the secondary electronic device with optical character recognition, or compare a screen shot with a stored screen shot. In yet another example, the method includes to determine the second rate based on the content includes analyzing the content with an artificial intelligence algorithm.

In one or more embodiments a computer program product comprising a non-signal computer readable storage medium is provided that include computer executable code to vary a rate at which context data is obtained by automatically obtaining context data related to a secondary electronic device at a first rate through a network, analyzing the context data to determine content associated with a user of the secondary electronic device, and varying the first rate to a second rate based on the content determined.

Optionally, the computer program product also automatically identifies at least one other secondary electronic device that has communicated with the secondary electronic device. In one aspect, the computer program product also automatically determines the second rate based on the content. To determine the second rate based on the content includes analyzing the content with an artificial intelligence algorithm.

### BRIEF DESCRIPTION OF THE DRAWINGS

FIG. 1 illustrates a system for monitoring electronic devices in accordance with embodiments herein.

FIG. 2 illustrates a simplified block diagram of an electronic device in accordance with embodiments herein.

FIG. 3 illustrates a simplified block diagram of an electronic device in accordance with embodiments herein.

FIG. 4 illustrates a process for monitoring an electronic device in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “content” as used throughout shall generally refer to any and all textual, audio or video information or data conveyed to or from an electronic device during operations of the electronic device. The content may represent various types of incoming and outgoing textual, audio, graphic and video content including, but not limited to, email, text messages, voicemail, calendar update, incoming phone calls, as well as other content in connection with social media and the like. The content may include a webpage, website, web search term, content typed into a document, pictures or other files uploaded, downloaded, etc. to and from the electronic device, or the like. The content may be determined by matching content to other identified content in a database, via an optical reader, optical character recognition (OCR), analyzing data, characteristics, attributes, parameters, etc. obtained related to a user or item analyzed, or the like, analyzed utilizing artificial intelligence algorithm, etc.

The term “context data” as used throughout shall generally refer to any and all data, information, parameters, characteristics, attributes, etc. related to a user of an electronic device, including a secondary electronic device. Context data can include keystroke data including typed information, website data including webpages, web searches, etc., user profile data, email data, text message data, or the like. Context data can be analyzed to determine content, and whether or not a user is behaving as desired by a school, employer, physician, or the like.

The term “rate” as used throughout shall generally refer to the frequency at which a monitoring application collects context data. The context data can be collected from any source, including secondary electronic devices, monitoring electronic devices, other inputs, etc. The frequency can be considered increased or decreased based on the amount of context data that is collected during a determined period of time, compared to the amount of context data that would have been collected without the increase or decrease. In one example, a rate may be once every five seconds, while in another example the first rate can be once every ten seconds, thirty seconds, minute, five minutes, thirty minutes, an hour, etc. Alternatively, the rate may be ten times every five minutes, ten times every thirty minutes, ten times every hour, etc. In yet another alterative, a monitoring application may provide monitoring for five seconds every minute, ten seconds every minute, thirty seconds every minute etc. The seconds in the example may be either consecutive or non-consecutive. For example, they collection of context data at a first rate may occur for one second every ten seconds for an hour. In the example, the collection may be a screen snap shot taken every ten second for the hour. Then, to increase to a second rate, the collection of context data occurs for five consecutive seconds every twenty seconds. So, instead of a snapshot once every ten second, the context data is collected by recording the screen for five consecutive seconds every twenty seconds for an hour. In this manner, the rate of context data collected increases from four seconds every twenty second to five seconds every twenty seconds.

The term “inappropriate content”, as used throughout shall generally refer to content that is considered undesirable, suspicious, or the like. Inappropriate content can be determined by an administrator, monitor, governing body, executive committee, etc. In example embodiments, the user of a monitoring electronic device utilizes a monitoring application to provide, define, etc. inappropriate content. As an example, in a work setting, inappropriate content may include website names and/or addresses related to sports, news, shopping, or the like that an employer does not desire to have their employees visiting during work hours. Alternatively, the inappropriate content may be related to guns, knives, cutting, etc. that may show a student or patient desires to harm themselves or others. To this end, the user of the monitoring device utilizes the monitoring application to provide what content is considered inappropriate content, including providing information for algorithms, mathematical functions, artificial intelligence algorithms, or the like that the monitoring application utilizes to determine if content is inappropriate content. Consequently, depending on the information provided by the user of the monitoring electronic device to the monitoring application, content that may be considered inappropriate content in one environment can be considered appropriate content in another environment.

The term “obtains” and “obtaining”, as used in connection with context data, data, information and the like, include at least one of i) accessing memory of an external device or remote server where the context data, signals, information, etc. are stored, ii) receiving the context data, signals, information, etc. over a wireless communications link between a monitoring electronic device and a secondary electronic device, and/or iii) receiving the context data, signals, information, etc. at a remote server over a network connection. The obtaining operation, when from the perspective of a monitoring electronic device, may include sensing new signals in real time, and/or accessing memory to read stored context data, signals, information, etc. from memory within the monitoring electronic device. The obtaining operation, when from the perspective of a secondary electronic device, includes receiving the context data, signals, information, etc. at a transceiver of the secondary electronic device where the context data, signals, information, etc. are transmitted from a monitoring electronic device and/or a remote server. The obtaining operation may be from the perspective of a remote server, such as when receiving the context data, signals, information, etc. at a network interface from a local external device and/or directly from a monitoring electronic device. The remote server may also obtain the context data, signals, information, etc. from local memory and/or from other memory, such as within a cloud storage environment and/or from the memory of a personal computer.

The terms “processor,” “a processor”, “one or more processors” and “the processor” shall mean one or more processors. The one or more processors may be implemented by one, or by a combination of more than one monitoring electronic device, secondary electronic device, a local device, a remote device, a server computing device, a network of server computing devices and the like. The one or more processors may be implemented at a common location or at distributed locations. The one or more processors may implement the various operations described herein in a serial or parallel manner, in a shared-resource configuration and the like.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

A monitoring system and methods are provided that control and vary the rate at which context data is obtained by a monitoring electronic device from plural secondary electronic devices. The monitoring device obtains the context data at a first rate, and then analyzes the context data to determine the content on each individual secondary electronic device. A determination is then made related to the appropriateness of the content. If the content is considered appropriate, the first rate can be decreased to a slower second rate. Alternatively, if content is not appropriate, or if other reasons exist for increasing the rate at which the context data is obtained, the rate is increased from the first rate to the second rate. In this manner, monitoring of secondary electronic devices that consistently have appropriate content is decreased to save memory space, while monitoring of secondary electronic devices that have inappropriate content is increased to improve safety, moral, etc.

In particular, a monitoring application is installed on a secondary electronic device. The monitoring application is monitoring based on a given frequency, or rate. For example, a student monitoring/safety application might perform OCR analysis on a display every few seconds. Alternatively, a monitoring application that monitors attention might upload a thumbnail of attendee displays periodically. Because these are reasonably “heavy” operations in terms of CPU/memory/network usage, they only run periodically. These monitoring applications are responsible for determining and providing the metadata that determines when something is in a suspicious or potentially undesired state. In another example, in a student monitoring/safety application, a potentially harmful, or inappropriate, word or phrase or image can be detected on the student's screen. When the inappropriate content is detected, the monitoring application increases the first rate of monitoring by an amount to a second rate capable of watching the suspicious, inappropriate activity/situation at the increase frequency, or rate. The increase depends on the particular monitoring application and whatever business logic the monitoring application uses to determine the necessary frequency. The increased frequency facilitates detection of additional information to determine if something suspicious, undesired, inappropriate is occurring. In one example, at the same time, the monitoring application can automatically determine all known recent the user of the secondary electronic device associations after the inappropriate content is determined so that an increase of the collection of context data for those most closely associated with the user of the secondary electronic device with the inappropriate content occurs. Again, the context data is collected utilizing metadata provided by the user of the monitoring electronic device utilizing the monitoring application. The collection of the context data includes analyzing any tracked communication between the secondary electronic device and other secondary electronic device (network traffic, file sharing, etc.) as well as any tracked communication between the user of the secondary electronic device and other users of secondary electronic devices (emails, messages, etc.) or any other manner of associating the user of the secondary electronic device with any other known users of other secondary electronic devices.

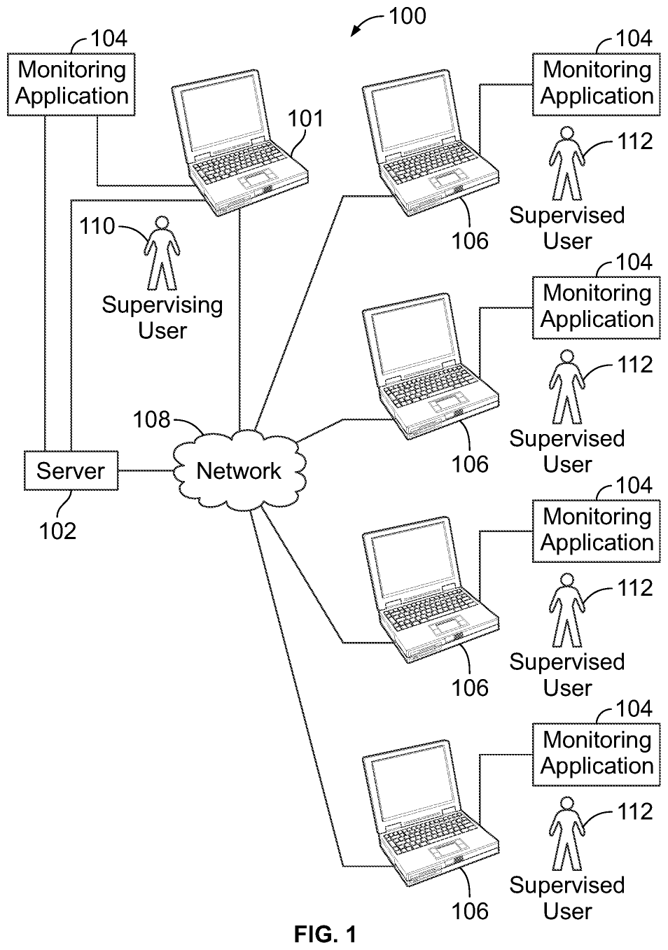

FIG. 1 provides an illustration of a system 100 to monitor plural electronic devices, including to increase and decrease the rate at which monitoring occurs in accordance with embodiments herein. In particular, first and second rates concern frequencies at which the monitoring application collects context data, including to increase the frequency from a first frequency to a second frequency when the content is classified as inappropriate content. The system 100 includes a monitoring electronic device 101 and/or server 102 with a monitoring application 104, one or more secondary electronic devices 106, and a network 108 operatively connected to the monitoring electronic device 101, server 102, and to the secondary devices 106. FIG. 1 depicts the monitoring electronic device 101 as a laptop computer and the secondary electronic devices also as plural laptop computers remote from the monitoring electronic devices. However, non-limiting examples of the monitoring electronic device 101 and secondary devices 106 also include tablet computers, personal digital assistants, desktop computers, cameras, televisions, video and audio players, gaming systems, vehicle information and communication systems, and the like.

According to control attributes defined by the monitoring application 104, the monitoring electronic device 101 and/or server 102 can be operated by supervising users 110 that monitor a supervised user 112. In example embodiments the supervising users may be parents, medical professionals, employers, teachers, coaches, landlords or other authorized individuals. Similarly, the supervised users 112 may be students, workers, employees, patients, etc. For example, teachers, principles, school administrator, etc. may monitor and manage the interaction of students with their personal secondary electronic devices 106 with the objective of benefitting the student's safety and education. In another example, medical professionals have interpersonal relationships with patients through their association at medical facilities for the purpose of health services. Accordingly, medical professionals, including mental health professionals may monitor and manage the patients' interaction with corresponding secondary electronic devices with the objective of benefitting each patient's safety and health. Employers similarly have interpersonal relationships with employees through their association at workplaces for the purpose of employment. Accordingly, employers may monitor and manage the employees interaction with corresponding secondary electronic devices 106 with the objective of benefitting the employee's productivity and morale.

Supervising users 110 are authorized to administer the monitoring application 104 to monitor operation of each secondary electronic device 102 for supervised users 112 as determined by the supervising user 110. Supervised users 112 are not authorized to administer or have access to the monitoring application 104. In particular, the monitoring application 104 in one example starts monitoring each secondary electronic device 106 at a first rate. In one example, the first rate may be once every five seconds, while in another example the first rate can be once every ten seconds, thirty seconds, minute, five minutes, thirty minutes, an hour, etc. Alternatively, the first rate may be ten times every five minutes, ten times every thirty minutes, ten times every hour, etc. In yet another alterative, the monitoring application 104 may provide monitoring for five seconds every minute, ten seconds every minute, thirty seconds every minute etc. The seconds in the example may be either consecutive or non-consecutive. To monitor the secondary electronic devices, the monitoring application 104 in one example obtains a screen snapshot every five seconds, ten seconds, thirty seconds, etc., obtains keystroke data every five seconds, ten seconds, thirty seconds, or the like. The OCR scanning and keystroke analysis can then be utilized to read text on a display of the secondary electronic device 102, determine content of what is being typed, etc.

In each instance, the monitoring application 104 obtains user context data related to the user. User context data can include keystroke data, typed data, website data including webpages, web searches, or the like, email data, user profile data, text message data, or the like. Accordingly, the monitoring application 104 varies the frequency of monitoring according to the context data. The frequency of the monitoring can be determined and dynamically updated based on the context data obtained that is related to the user, or another user related to the user. Consequently, the first and second rates concern frequencies at which the monitoring application collects the context data from the at least one secondary electronic device, and the monitoring application configures one or more processors to increase the frequency from a first frequency to a second frequency when the content is classified as inappropriate content.

The variance can be binary based, providing for two states of operation, such as an on/off switch. For example, the monitoring application 104 can dynamically update the functionality by increasing frequency of monitoring from a first rate that is predetermined to a second rate that is predetermined. As an example, the first rate may be obtaining context data every ten second, while the second rate is obtaining context data every five seconds. Still, the ten seconds and five seconds are static, and the only determination made is whether context data should be obtained at the static first rate or static second rate. Alternatively, the variance in the monitoring frequency can be non-binary based, providing for multiple states of operation. For instance, the monitoring application 104 can determine the exact rate at which monitoring frequency is varied depending on the context data itself. In this manner, the first rate may be every 10 second and the second rate may be every 8 seconds depending on the determination. Alternatively the first rate is obtaining context data every ten seconds and the second rate is obtaining context data every six seconds. In this manner the second rate can vary based on the content determined, instead of just providing a static second range (five seconds in the previous example). Consequently, in each method, the monitoring application 104 dynamically updates the frequency continuously as context data is obtained and content determined. Therefore, for users that do not have content indicating undesired behavior, the frequency can be reduced, saving memory space, and improving processing times. Simultaneously, for users having content indicating undesired behavior, the frequency of monitoring increases to provide better safety for that individual.

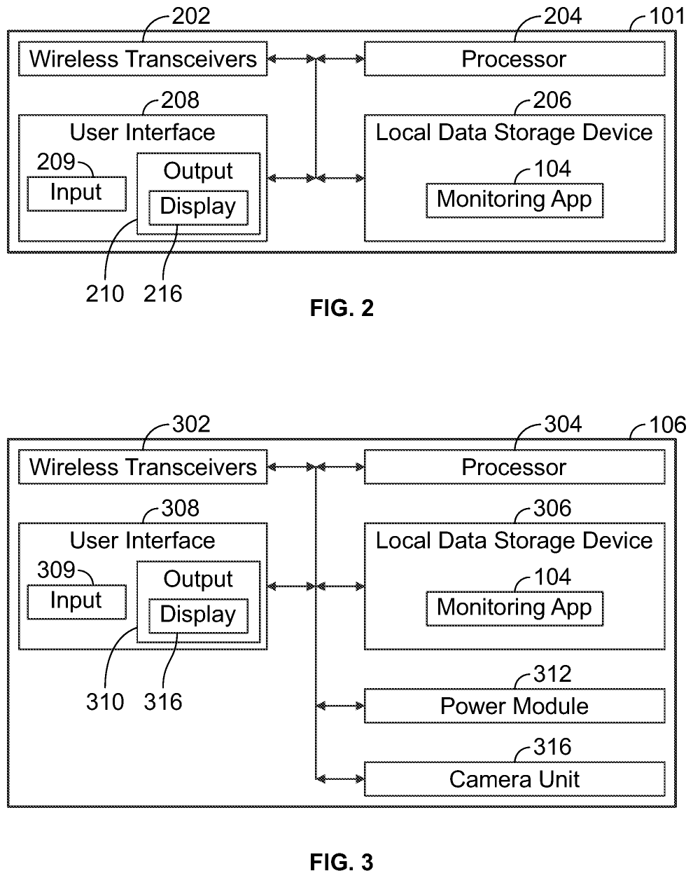

FIG. 2 illustrates a simplified block diagram of the monitoring electronic device 101 and/or server 102 of FIG. 1 in accordance with an embodiment. The monitoring electronic device 101 includes a housing with components such as one or more wireless transceivers 202, one or more processors 204 (e.g., a microprocessor, microcomputer, application-specific integrated circuit, etc.), one or more local data storage devices 206 (also referred to as a memory portion), a user interface 208 which includes one or more input devices 209 and one or more output devices 210, a power module 212, and a display 218. All of these components can be operatively coupled to one another and can be in communication with one another by way of one or more internal communication links, such as an internal bus.

Each transceiver 202 can utilize a known wireless technology for communication. Exemplary operation of the wireless transceivers 202, in conjunction with other components of the monitoring electronic device 101, may take a variety of forms. For example, the wireless transceivers 202 may operate in a way which, upon reception of wireless signals, the components of the monitoring electronic device 101 may detect communication signals from the secondary electronic devices 106 and the transceiver 202 may demodulate the communication signals to recover incoming information.

Among other things, the monitoring application 104 manages operation of the processor 204 in association with monitoring the secondary electronic devices 106. The processor 204 analyzes the context data from the secondary electronic devices 106 to determine the appropriateness of content being displayed, input, etc. on, into, etc. the secondary electronic device 106. In example embodiments, an algorithm, artificial intelligence algorithm, lookup table, decision tree, mathematical model, mathematical function, or the like is utilized to analyze context data to determine the appropriateness of content on the secondary electronic devices 106. The monitoring application 104 directs the processor 204 to make the determination based on the context data.

The local data storage device 206 can encompass one or more memory devices of any of a variety of forms (e.g., read only memory, random access memory, static random access memory, dynamic random access memory, etc.) and can be used by the processor 204 to store and retrieve data. The data that is stored by the local data storage device 206 can include, but need not be limited to, operating systems, applications, user collected content, and informational data. Each operating system includes executable code that controls basic functions of the device, such as interaction among the various components, communication with external devices via the wireless transceivers 202, and storage and retrieval of applications and data to and from the local data storage device 206. Each application includes executable code that utilizes an operating system to provide more specific functionality for the communication devices, such as file system service and handling of protected and unprotected data stored in the local data storage device 206.

The local data storage device 206 also stores context data, data input through the user interface 208, content determined through analysis of the context data, algorithms utilized determine appropriateness of content based on the context data, lookup tables utilized to determine the appropriateness of content based on the context data, comparison data utilized to determine the appropriateness of content based on the context data, etc. The monitoring application 104 can be in communication with the local data storage device to obtain context data, historical context data, content, or the like for analysis and implementing a method for managing monitoring of secondary electronic device. Other applications stored in the local data storage device 206 include various application program interfaces (APIs), some of which provide links to/from a cloud hosting service.

The user interface 208 permits the user to operate the monitoring electronic device 101 for any of its intended purposes, such as administering the monitoring application 104, operating software applications, electronic communication, listening to audio media, viewing video media, and the like. To that end, the input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a display 218, one or more light emitting diode indicators, an audio output device such as a speaker, alarm and/or buzzer, and a mechanical output device such as a vibrating mechanism. The display 218 may be touch sensitive to various types of touch and gestures. As further examples, the output device 210 may include a touch sensitive screen, a non-touch sensitive screen, a text-only display, a smart phone display, an audio output (e.g., a speaker or headphone jack), and/or any combination thereof.

The user interface 208 also permits the user to provide inputs for use by the monitoring application 104. For example, the user of the monitoring electronic device 101 may obtain and input settings associated with the monitoring application. In one example, a user may input the first rate, second rate, etc. In another example, the user may input data and information that is utilized by the monitoring application to determine whether an activity may be considered desired or undesired behavior. As one example, in a school setting, website data including certain websites may be considered by a monitor inappropriate such as entertainment based websites, sports based websites, news based websites, etc. In particular, a school may desire a secondary electronic device only be utilized for academic purposes. Alternatively, in a mental health facility, the user of the monitoring electronic device 101 may have no problems with websites that are entertainment based, sports based, news based, etc. and instead desire to monitor for websites for a patient that could indicate potential self-harm, or harm to others. To this end, the user of the monitoring electronic device 101 may input numerous websites, search terms, etc. that the user considers to be undesirable or inappropriate. To this end, in one example, the user inputs can be utilized in association with an artificial intelligence algorithm that analyzes inputs from secondary electronic devices to determine if content is undesirable or inappropriate.

In addition the user interface 208 may also be utilized to manually input auxiliary context data that can be utilized in determining the rate at which additional context data is obtained from a particular secondary electronic device user or users for determining user content. For example, in a school setting, if a teacher has reason to believe a student is being bullied by other students, if a teacher sees inappropriate material on a student's screen, if known friends or associates of a particular student have gotten in trouble recently for looking at inappropriate materials, etc. the teacher as the user of a monitoring electronic device 101 can provide such auxiliary context data, or even request the frequency of monitoring increase for a period. Similarly, if in a work setting it is known that during certain meetings employees do not pay attention, surf the internet, send personal emails, etc. a boss that is the user of the monitoring device may provide auxiliary context device in the form of a manual input that increases the rate or frequency of monitoring during the time period of the meeting for all secondary electronic devices of individuals attending the meeting. Alternatively, the monitoring application 104 when analyzing the context data and content can determine if certain inappropriate behavior is occurring in response to an event, time period, etc. For example, in a work setting, employees may be prone to surf the internet instead of work after coming back from lunch. As a result a spike in inappropriate content may be determined for numerous employees during this period, resulting in increased monitoring rates for all employees during this period.

FIG. 3 illustrates a simplified block diagram of the secondary electronic device 106 of FIG. 1 in accordance with an embodiment. The secondary electronic device 106 includes a housing with components such as one or more wireless transceivers 302, one or more processors 304 (e.g., a microprocessor, microcomputer, application-specific integrated circuit, etc.), one or more local data storage devices 306 (also referred to as a memory portion), a user interface 308 which includes one or more input devices 309 and one or more output devices 310, a power module 312, a camera unit 316, and a display 318. All of these components can be operatively coupled to one another and can be in communication with one another by way of one or more internal communication links, such as an internal bus.

The user interface 308 permits the user to operate the secondary electronic device 106 for any of its intended purposes, including operating software applications, electronic communication, capturing images with the camera unit 316, listening to audio media, viewing video media, and the like. To that end, the input and output devices 309, 310 may each include a variety of visual, audio, and/or mechanical devices. For example, the input devices 309 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 310 can include a visual output device such as a display screen 318, one or more light emitting diode indicators, an audio output device such as a speaker, alarm and/or buzzer, and a mechanical output device such as a vibrating mechanism. The display screen 318 may be touch sensitive to various types of touch and gestures. As further examples, the output device 310 may include a touch sensitive screen, a non-touch sensitive screen, a text-only display, a smart phone display, an audio output (e.g., a speaker or headphone jack), and/or any combination thereof.

Each transceiver 302 can utilize a known wireless technology for communication. Exemplary operation of the wireless transceivers 302, in conjunction with other components of the secondary electronic device 106, may take a variety of forms. For example, the wireless transceivers 302 may operate in a way which, upon reception of wireless signals, the components of the secondary electronic device 302 may detect communication signals from the monitoring electronic device 101.

Among other things, the monitoring application 104 manages operation of the processor 304 in association with monitoring communication signals to and from the secondary devices 106. The monitoring application 104 in one example is stored in the storage device 206 of the monitoring electronic device and communicates signals to secondary electronic devices 106 to obtain context data, content, make determinations, etc. In another example, the monitoring application 104 is stored in the storage device 306 of individual secondary electronic devices to provide communications as required to the monitoring electronic device 101. In yet another example, a monitoring application 104 is stored in the storage device 206 of the monitoring electronic device and another monitoring application 104 is stored in the storage device 306 of a secondary electronic device 106, and the monitoring application 104 of the monitoring electronic device 101 communicates with the monitoring application 104 of each secondary electronic device 106 to obtain context data, content, make determinations, and implement methods and processes as described herein.

The local data storage device 306 can encompass one or more memory devices of any of a variety of forms (e.g., read only memory, random access memory, static random access memory, dynamic random access memory, etc.) and can be used by the processor 304 to store and retrieve data, including context data. The data that is stored by the local data storage device 306 can include, but need not be limited to, operating systems, applications, user collected content data, user profiles, and informational data. Each operating system includes executable code that controls basic functions of the device, such as interaction among the various components, communication with external devices via the wireless transceivers 302, and storage and retrieval of applications and data to and from the local data storage device 306. Each application includes executable code that utilizes an operating system to provide more specific functionality for the communication devices, such as file system service and handling of protected and unprotected data stored in the local data storage device 306.

The local data storage device 306 stores various applications including, but not limited to, the monitoring application 104. The monitoring application 104 manages one or more operations of the secondary electronic device 106. The monitoring application 104 includes instructions accessible by the one or more processors 304 to direct the processor 304 to implement the methods, processes and operations described herein including, but not limited to, the methods, processes and operations illustrated in the Figures and described in connection with the Figures. Other applications stored in the local data storage device 306 include various application program interfaces (APIs), some of which provide links to/from a cloud hosting service.

The user interface 308, input devices 309, output devices 310, camera unit 316, and display 318 may all be utilized by the monitoring application to obtain context data related to the user. For example, an input device 309 may be a keyboard where keystroke data obtained from the keystrokes on the keyboard are analyzed to determine what is being typed by a user. In one example, the input device may be analyzed to determine searches in search engines, websites visited, files uploaded and downloaded, etc. In another example, the camera unit 316 may be utilized to record actions of the user. The actions can include sleeping during a meeting, class, seminar, etc., inappropriate gestures or communications, a student, worker, etc. leaving the secondary electronic device during a meeting, class, seminar, etc., facial data that may be used by facial recognition software to identify the individual sitting at the secondary electronic device, facial data that can be analyzed to determine the mode or emotional state of the user of the secondary electronic device, or the like. In addition, the display 318 can be utilized for obtaining context data including screen shots of what the user has on their display at any given time, file folder names, etc. In each instance each component provides context data that may be analyzed to determine the content, and to this end, the appropriateness of the content being viewed by a user of the secondary electronic device.

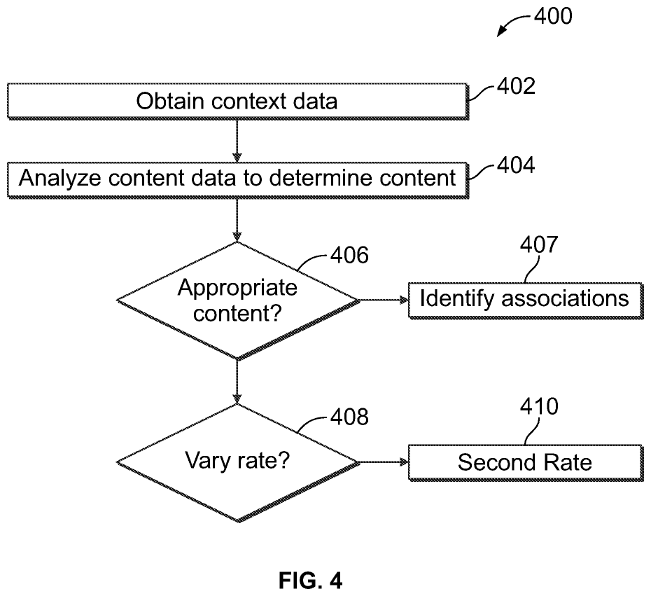

FIG. 4 illustrates a process for dynamically varying the rate at which an electronic device is monitored. The operations of FIG. 4 in example embodiments can be carried out by the one or more processors of a monitoring electronic device, one or more processors of a secondary electronic device, a combination thereof, etc. In example embodiments, the monitoring electronic device of FIGS. 1 and 2 and/or the secondary electronic device of FIGS. 1 and 3 are utilized to carry out the process. The one or more processors of each of the monitoring electronic device and secondary electronic device perform the process and/or method in response to execution of instructions such as in a monitoring application and/or other applications stored in a local data storage device. The first and second rates concern frequencies at which the monitoring application collects the context data from the at least one secondary electronic device. To this end, one or more processors are configured to increase the frequency from a first frequency to a second frequency when the content is classified as inappropriate content.

At 402, the one or more processors obtain context data related to a secondary electronic device at a first rate through the network. In example embodiments the secondary electronic device may be a laptop computer, computing device, iPad, iPod, tablet, smart phone, or the like. The user of the secondary electronic device may be a student, worker, employee, patient, etc. that is being supervised by a user of a monitoring electronic device. The user of the secondary electronic device may be a principle, teacher, coach, boss, supervisor, doctor, etc. that desires to monitor information related to the user of the secondary electronic device. At least one of, and in several examples, both the monitoring electronic device and secondary electronic device include a monitoring application that includes instructions for obtaining context data from the secondary electronic device, analyzing the context data, determining content associated with the context data, and increasing and decreasing the rate at which the context data is obtained. The context data can include keystroke data form keystrokes on an input device, screen shots or screen captures, email data, imaging data of a user obtained from a camera unit, data manually input by the user of the monitoring electronic device, information obtained from a user profile, or the like. To this end, the context data input by a user of the monitoring electronic device may be considered auxiliary context data. In addition, the user profile may include the name of the user of the secondary electronic device, known friends or associates of the user of the secondary electronic device, groups, clubs, teams, etc. of the user of the secondary electronic device, or the like. The context data can also include the frequency of communications between individuals. For example, emails, text messages, etc. between individuals, and groups of individuals can be monitored for frequency, such that if an individual is found to have inappropriate content, individuals that frequently communicate with that individual have a higher likelihood of also having the inappropriate content. In all, the context data includes any data, information, etc. that may be utilized to obtain and to determine the content of the context data so that a determination can be made regarding the appropriateness of the content, whether the content evidences a safety issue may be presented, etc.

At 404, the one or more processors can analyze the context data to determine content associated with a user of the secondary electronic device. The analysis provided in example embodiments can include utilizing an OCR to determine the content, utilizing an optical reader to determine the content, utilizing facial recognition technology to determine the content, comparing images, reading emails, determining website data such as domain names and addition website based content, determining frequency of communications between secondary electronic devices, or the like. In one example, an OCR may read text on a display of the secondary electronic device of an email sent to another student related to how the student is being bullied by other students. In another example, a screen shot may show that a student is visiting a website related to how to purchase a gun. In yet another example, a camera data may be analyzed to determine the content of an employee that is sleeping during a meeting. In other example, a pornographic picture may be attached to an email from one student to another, and analyzed by a scanner to identify the content. In another embodiment, a user profile may be obtained that includes identifying a user's friends, groups, affiliations, associates, etc., such that being associated with an individual with inappropriate material can be content. Analysis can also occur on keystroke data from keystrokes of an input device indicating a working is simply preparing a memo for work, and this is the content. Still, the analysis can be provided to determine the content, so that a determination can be made whether the content is considered appropriate.

At 406, a determination is made whether the content is appropriate. In one example, the content may be compared to previous content to make the determination. In another example, an algorithm related to the content may be utilized to determine the appropriateness of the content. In yet another example, an artificial intelligence algorithm related to the content may be utilized. For example, a lookup table may include activities that result in content being inappropriate. One activity may be sleeping during meetings; therefore, the inappropriate content is that an employee is sleeping during a meeting. In another example, an algorithm may provide different weights to information. So, certain words may result in specific scores. The terms “gun” and “shoot” may each be considered three points, the terms “die” and “kill” five points, and the algorithm may add points up for each word that is typed. If during a given period, such as one day, one week, two weeks, etc., a predetermined threshold, such as fifteen points, twenty-five points, etc. is exceeded, the content may be considered inappropriate. Similarly, certain words such as “suicide” may automatically cause the content to be considered inappropriate.

If at 406, content is determined to be inappropriate, then at 407, one or more processors identify recent associations related to the user of the secondary electronic device. In particular, metadata is obtained from the user of the secondary electronic device, including recent other users emailed, texted, communicated with, frequent users emailed, texted, communicated with, etc. to identify such other users. The identification of the recent associations can then be used as context data in making a determination of whether to increase the rate at which context data is obtained for the other user.

In one example, a student may email an inappropriate joke with an inappropriate attachment to another student. The one or more processors may then determine the five individuals that receive the most emails from the sender, and utilize the association as context data to determine whether to increase whether to increase the first rate to a second rate to obtain more context data from those five individuals.

If at 406, a determination is made that the content is appropriate, then at 408, a determination is made whether to change the rate at which the context data is monitored from a first rate to a second rate. For example, in the method, the one or more processors can obtain context data at a first rate of once every ten seconds, twenty seconds, minute, etc. Then, if the content of a user of a secondary electronic device remains appropriate for a threshold time period, the rate can be reduced from the first rate to a second rate. In one example, the rate is reduced from once every ten seconds to once every twenty seconds. In an example, the time period can be one week, two weeks, one month, two months, etc. Optionally, additional thresholds may be provided to further reduce the rate after another threshold period.

Alternatively, if at 406 the content is considered inappropriate content, after the associates are identified at 407, again the determination at 408 is made to change the rate, or frequency that the context data is collected. Only, in this example, because the content has been determined to be inappropriate content, the rate is automatically increased. So in one example, the first rate can be thirty seconds, and after the inappropriate content is identified, the rate is increased to provide a second rate that occurs every ten seconds.

If at 408 a determination is made that the first rate needs to increase or decrease based on the content, then at 410, the one or more processors vary the first rate to a second rate based on the content determined. In this manner, when a user of a secondary electronic device behaves appropriately, the rate at which context data is obtained can be decreased, saving memory space. Meanwhile, when certain users display inappropriate behaviors, a certain time period is determined to have increased inappropriateness, certain users communicate often with a user showing inappropriate behavior, etc. the rate of obtaining context data can increase to enhance safety, improve behavior, moral, etc. of the users of the secondary electronic devices. If at 408, the rate remains the same, then the context data continues being obtained at the same rate.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A system for monitoring at least one secondary electronic device comprising:
a monitoring application installed on the at least one secondary electronic device;
a monitoring electronic device configured to electronically communicate with the monitoring application on the at least one secondary electronic device via a network;
the monitoring electronic device having a memory storing program instructions and one or more processors that, when executing the program instructions, are configured to:
obtain context data from the monitoring application at a first rate, the context data related to the secondary electronic device;
analyze the context data to determine content associated with a user of the secondary electronic device; and
vary the first rate to a second rate based on the content determined.

2. The system of claim 1, the one or more processors further configured to obtain auxiliary context data from a manual input by a user of the monitoring electronic device.

3. The system of claim 1, wherein the context data includes at least one of keystroke data, website data, or email data.

4. The system of claim 1, the one or more processors further configured to obtain a user profile of the user of the secondary electronic device.

5. The system of claim 4, wherein the user profile includes names of friends or associates.

6. The system of claim 1, wherein the first and second rates concern frequencies at which the monitoring application collects the context data from the at least one secondary electronic device, the one or more processors further configured to increase the frequency from a first frequency to a second frequency when the content is classified as inappropriate content.

7. The system of claim 1, wherein to analyze the context data, the one or more processors are further configured to read text on a display of the secondary electronic device with optical character recognition.

8. The system of claim 1, wherein to analyze the context data, the one or more processors are further configured to compare a screen shot with a stored screen shot.

9. The system of claim 1, wherein the one or more processors are further configured to determine the second rate based on the content.

10. The system of claim 9, wherein to determine the second rate based on the content includes analyzing the content with an artificial intelligence algorithm.

11. The system of claim 1, wherein the first rate is less than the second rate.

12. A computer implemented method to monitor a secondary electronic device comprising:
under control of one or more processors including program instructions to:
obtain context data related to the secondary electronic device at a first rate through a network;
analyze the context data to determine content associated with a user of the secondary electronic device; and
vary the first rate to a second rate based on the content determined.

13. The method of claim 12, wherein the program instructions further to:
obtain auxiliary context data from a manual input by a user of a monitoring electronic device.

14. The method of claim 12, wherein the program instructions further to:
obtain a user profile of the user of the secondary electronic device.

15. The method of claim 12, wherein the program instructions further to identify at least one other secondary electronic device that has communicated with the secondary electronic device.

16. The method of claim 12, wherein to analyze the context data, the one or more processors are further configured to read text on a display of the secondary electronic device with optical character recognition, or compare a screen shot with a stored screen shot.

17. The method of claim 12, wherein the program instructions further to determine the second rate based on the content, wherein to determine the second rate based on the content includes analyzing the content with an artificial intelligence algorithm.

18. A computer program product comprising a non-signal computer readable storage medium comprising computer executable code to vary a rate at which context data is obtained by automatically:
obtaining context data related to a secondary electronic device at a first rate through a network;
analyzing the context data to determine content associated with a user of the secondary electronic device; and
varying the first rate to a second rate based on the content determined.

19. The computer program product of claim 18 further automatically: identifying at least one other secondary electronic device that has communicated with the secondary electronic device.

20. The computer program product of claim 18 further automatically: determining the second rate based on the content, wherein to determine the second rate based on the content includes analyzing the content with an artificial intelligence algorithm.
